(19) United States
(12) Patent Application Publication
(10) Pub. No.: US 2005/0262171 A1
(43) Pub. Date: Nov. 24, 2005

(54) Method of querying multimedia data via internet

(75) Inventor: Chuan-Ying Chang, Taipei City (TW)

Correspondence Address: BACON & THOMAS, PLLC, 625 SLATERS LANE, FOURTH FLOOR, ALEXANDRIA, VA, 22314, US

(73) Assignee: CALIBER MULTIMEDIA TECHNOLOGY & TRADING CO. , LTD., TAIPEI CITY (TW)

(21) Appl. No.: 10/988,602

(22) Filed: Nov. 16, 2004

(30) Foreign Application Priority Data
May 13, 2004 (TW) 93113510

(51) Int. Cl. G06F 17/30

(52) U.S. Cl. 707/204

(57) ABSTRACT

A method of querying multimedia data via Internet fulfills the user's query of multimedia data between a client and a server via Internet. The client includes a media playback device, an iconographical file having a plurality of file numbers, and a click-on device. The server includes a query-analyzing program and a multimedia database having a plurality of multimedia data files. When a noun of a specific object is selected by the click-on device, a file number corresponding to the noun of the specific object is indexed by the iconographical file, then the corresponding file number is sent to the server. Meanwhile, the query-analyzing program sources the multimedia data file corresponding to the file number and then sends the same to the client via Internet. When the client receives the multimedia data file, they are presented on the media playback device.

### BACKGROUND OF THE INVENTION

1. Field of the Invention

The present invention relates generally to Internet technology, and more particularly to a method of querying multimedia data via Internet.

2. Description of the Related Art

As Internet has been highly developed and popular worldwide, people can interact with and learn from a variety of persons, affairs, and objects and access much information and many interactions concerning daily life, learning, working, business, entertainment, etc. via Internet. In face of millions of information or WWW (World-Wide Web) pages, however, a variety of terminology in specific technical fields, such as zoology, botany, character, apparatus, antiquity, architecture, etc., will appear casually and even the most encyclopedic person fails to know the meaning, tangible appearance, and other details of every single one of the terminology. Moreover, there is still none of any system, which allows the user to promptly and effectively query the nouns or objects shown in the WWW pages on Internet and then renders corresponding multimedia data, like images, words, and sounds, to the nouns or objects.

### SUMMARY OF THE INVENTION

The primary objective of the present invention is to provide a method of querying multimedia data via Internet, which allows the user to query its desired nouns or objects on Internet and promptly and effectively renders corresponding multimedia data.

The foregoing objective of the present invention is attained by the method, which fulfills the user's query of multimedia data between a client and a server via Internet, wherein the client includes a media playback device, a click-on device, and an iconographical file, and the server includes a query-analyzing program and a multimedia database. The iconographical file has a plurality of file numbers for indexing nouns of specific objects. The media playback device displays WWW pages or graphical and literal information. The click-on device is provided for operating by the user to select the nouns of the desired objects shown in the WWW pages or the graphical and literal information and then enabling the nouns of the selected objects to be indexed by the iconographical file and sending the file numbers corresponding to the nouns of the selected objects to the server. The multimedia database has a plurality of multimedia data files. After the file numbers of the nouns of the selected objects are received, the query-analyzing program sources the multimedia data files corresponding to the file numbers and then sends the same to the client via Internet. When the client receives the multimedia data files, they are presented on the media playback device. Accordingly, the user on the client can query the nouns of the specific objects shown in the WWW pages or documents via Internet and source the multimedia data corresponding to the nouns of the specific objects.

### BRIEF DESCRIPTION OF THE DRAWINGS

FIG. 1 is a diagram of a first preferred embodiment of the present invention.

FIG. 2 is a flowchart of the first preferred embodiment of the present invention.

FIG. 3 is a diagram of a second preferred embodiment of the present invention.

FIG. 4 is a flowchart of the second preferred embodiment of the present invention.

### DETAILED DESCRIPTION OF PREFERRED EMBODIMENTS

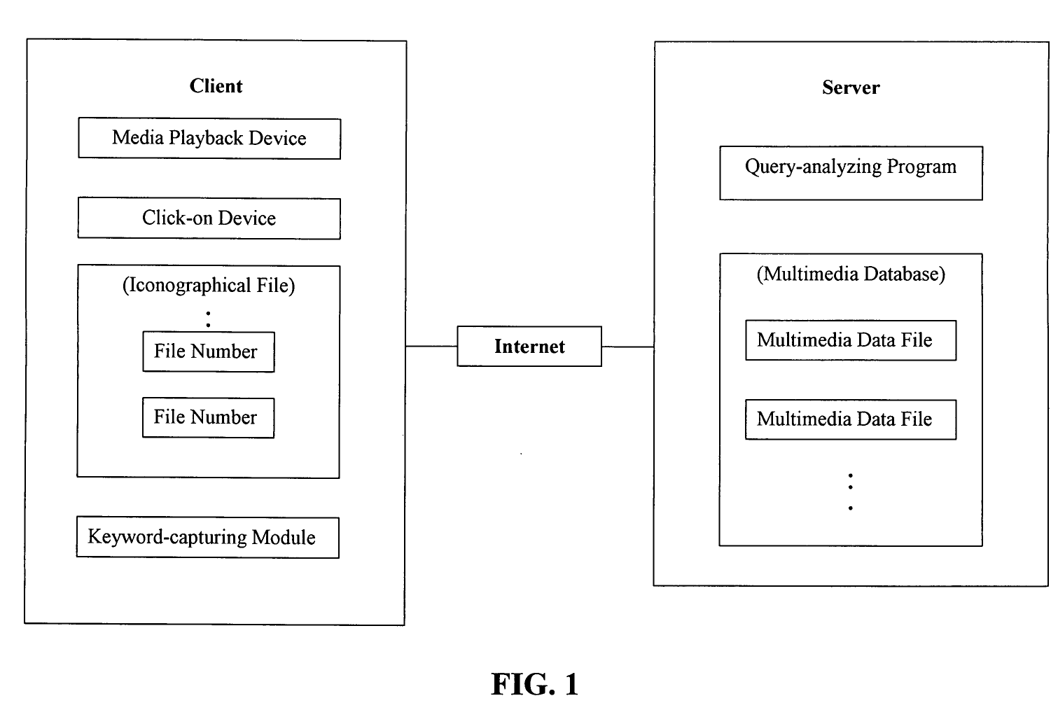

Referring to FIG. 1, a method of querying multimedia data via Internet is constructed according to a first preferred embodiment of the present invention, fulfilling the user's query of multimedia data between a client 11 and a server 21 via Internet 99.

The client 11 is embodied as a computer system, which is comprised of a media playback device 12, a click-on device 14, an iconographical file 16, and a keyword-capturing module 18. The media playback device 12 has a screen (not shown) for displaying the WWW pages or the graphical and literal information. The iconographical file 16 has a plurality of file numbers 17 for indexing the nouns of specific objects. The click-on device 14 is provided for operating by the user to click on and select the nouns of desired objects shown in the WWW pages or the graphical and literal information and then enabling the nouns of the selected objects to be indexed by the iconographical file 16 and further sending the file numbers 17 corresponding to the nouns of the selected objects to the server 21. The keyword-capturing module 18 can be downloaded from Internet and then installed into the client 11 for facilitating the user to input a noun of a desired object by a keyboard (not shown) or to capture a noun of an object shown on the screen (not shown) of the media playback device 12 by a cursor (not shown).

The server 21 is installed with a query-analyzing program 22 and a multimedia database 24. The multimedia database 24 has a plurality of multimedia data files 25. When the corresponding file numbers 17 are received from the client 11, the query-analyzing program 22 sources the multimedia data files 25 corresponding to the file numbers 17 and transmits the multimedia data files 25 to the client 11 via Internet.

When the client 11 receives the multimedia data files 25, the multimedia data files 25 are played or displayed on the media playback device 12. Therefore, the user on the client 11 can query the nouns of specific objects shown in WWW pages or documents and read the multimedia data corresponding to the nouns of the specific objects via Internet 99.

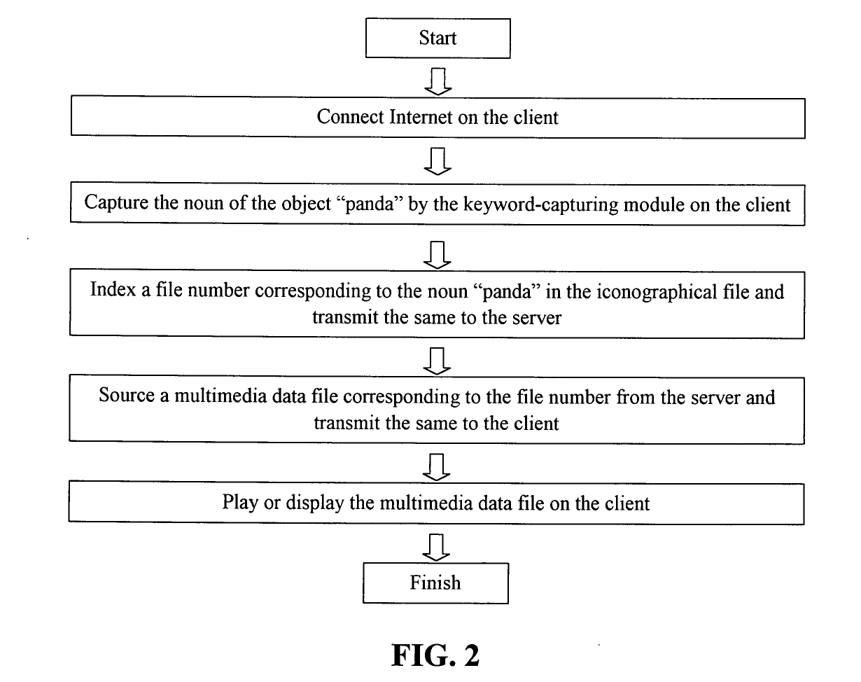

Referring to FIGS. 1 and 2, while querying the noun of an object, such as “panda”, by the method of the first preferred embodiment of the present invention, the user can use the computer system of the client 11 to connect Internet 99 and click on or select the noun “panda” on the WWW page or document by the click-on device 14 as well as the keyword-capturing module 18. Then, the client 11 indexes the file number 17 corresponding to the noun “panda” in the iconographical file 16 and transmits the corresponding file number 17 to the server 21 via Internet 99. After receiving the file number 17 from the client 11, the server 21 sources the multimedia data files 25, such as relevant photographs, animations, and words for “panda”, in the multimedia database 24 and then transmits the same to the client 11. After the client 11 receives the multimedia data files 25, the multimedia data files 25 are played or displayed on the media playback device 12. In other words, the user can click on the noun of a desired object to easily obtain detailed its literal or audio and video representation by the present invention.

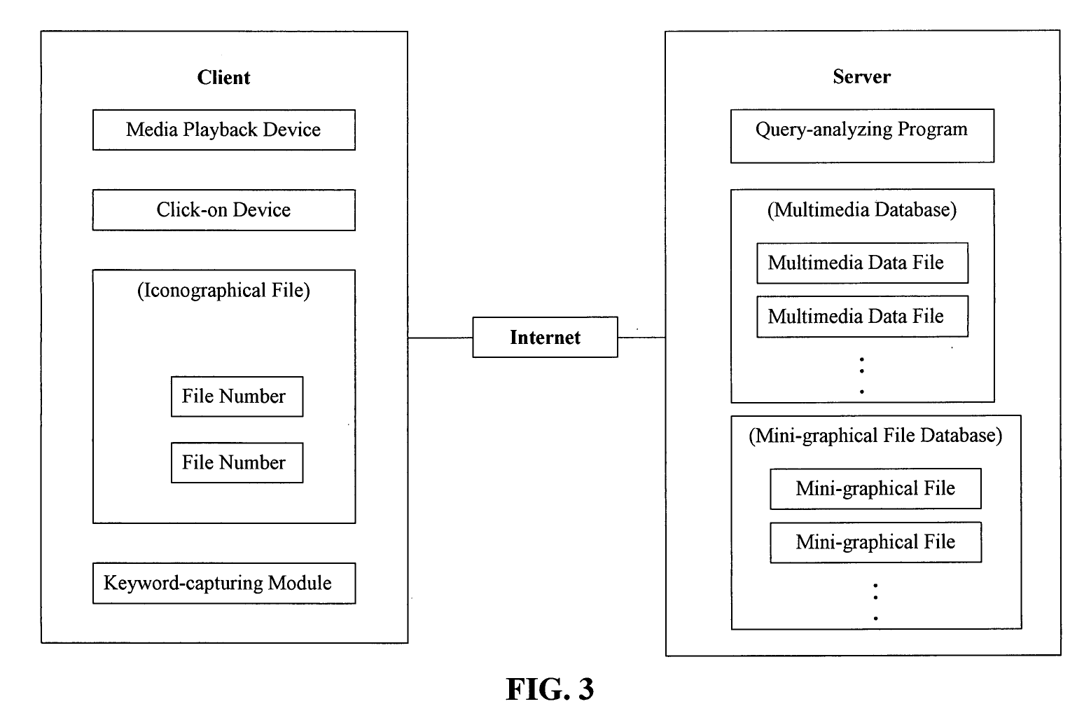

Referring to FIG. 3, the method of querying multimedia data via Internet is constructed according to a second preferred embodiment of the present invention, being similar to the aforementioned embodiment but having difference as recited below.

The server 21′ includes a mini-graphical file database 29, which has a plurality of mini-graphical files 291 corresponding to the file numbers 17′. The file size of each mini-graphical file 291 is much smaller than the multimedia data file 25′. When the user inputs or selects the noun of a desired object, the client 11′ sources the file number 17′ corresponding to the noun of the desired object from the iconographical file 16′ and transmits the same to the server 21′ via Internet 99. After receiving the file number 17′ from the client 11′, the server 21′ indexes the mini-graphical file 291 corresponding to the file number 17′ in the mini-graphical file database 29 and displays the same on the media playback device 12′. Then, the user can click on the mini-graphical file 291 to download the corresponding multimedia data file 25′ into the client 11′, and then the multimedia data file 25′ is played or displayed on the media playback device 12′.

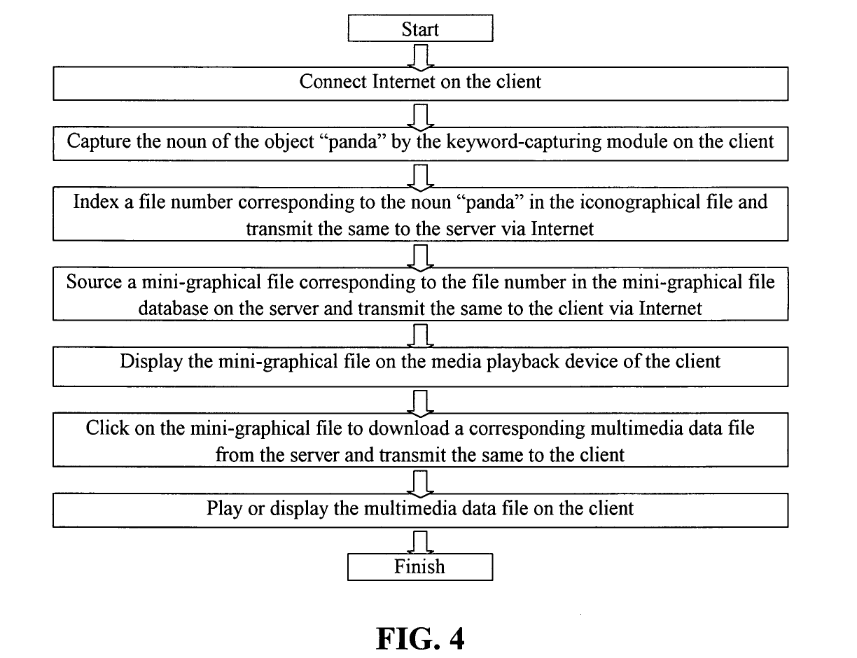

Referring to FIGS. 3 and 4, when the mini-graphical file 291 is displayed on the media playback device 12′, the user can preview the mini-graphical file 291 and then decide whether the multimedia data files 25′ should be further downloaded, thereby being diverse and user-friendly in design.

As recited above, the present invention includes advantages as follows.
1. The present invention allows the user to quickly access the illustration and audio and video information corresponding to the nouns of the objects that are to be queried, and further immediately provide the user with the relevant multimedia information.
2. Because the multimedia data files are installed in the server, suppliers of the multimedia data files can directly update or install new data in the server to avoid the inconvenience of updating database on each client if the database is installed in the client, and the user can immediately do the query on the client without learning how to update the database.

1. A method of querying multimedia data for fulfilling the user's query of multimedia data between a client and a server via Internet, wherein:
said client comprises a media playback device having a screen for presenting WWW pages or graphical and literal information, a click-on device for operating by the user to click on and select the nouns of objects shown in the WWW pages or graphical and literal information, and an iconographical file having a plurality of file numbers for indexing said selected nouns of the objects, whereby said nouns of the objects are indexed by said iconographical file and then said client transmits said corresponding file numbers to said server after the user clicks on the nouns of the objects;
said server is installed with a query-analyzing program and a multimedia database, said multimedia database having a plurality of multimedia data files, whereby after receiving said file numbers from said client, said query-analyzing program sources corresponding multimedia data files from said multimedia database and transmits said multimedia data files to said client via Internet;
said client presents said multimedia data files on said media playback device after receiving said multimedia data files;
whereby the user on the client can query the nouns of specific objects on the WWW pages or in the documents via Internet and source the corresponding multimedia data.

2. The method as defined in claim 1, wherein said client further comprises a keyword-capturing module for conveniently inputting the nouns of the objects by the user or capturing the nouns of the objects shown on said screen of said media playback device.

3. The method as defined in claim 2, wherein said keyword-capturing module allows the user to input the nouns of the objects by a keyboard or to capture the nouns of the objects on the screen of said media playback device of said client by a cursor.

4. The method as defined in claim 2, wherein said keyword-capturing module is installed in said client.

5. The method as defined in claim 4, wherein said keyword-capturing module is downloaded from Internet before it is installed in said client.

6. The method as defined in claim 1, wherein said client is a computer system.

7. The method as defined in claim 1, wherein said server further comprises a mini-graphical file database having a plurality of mini-graphical files corresponding to the nouns of the selected objects and said file numbers of said iconographical file; said query-analyzing program indexes the mini-graphical files corresponding to the nouns of the selected objects from said mini-graphical file database, then the corresponding mini-graphical files are presented on said screen of said media playback device of said client for clicking on by the user, and further said mini-graphical files are indexed by said iconographical file and then said client transmits the corresponding file numbers to said server after the user clicks on the mini-graphical files.

8. The method as defined in claim 7, wherein said mini-graphical file comprises a much smaller size than that of said multimedia data file.
